(19) United States
(12) Patent Application Publication
(10) Pub. No.: US 2015/0178779 A1
(43) Pub. Date: Jun. 25, 2015

(54) SYSTEM AND METHOD FOR CREATING, MANAGING, AND SERVING ONLINE ENHANCED CLICK ADVERTISING CAMPAIGNS

(71) Applicant: Underground Elephant, San Diego, CA (US)

(72) Inventors: Keola Malone, San Diego, CA (US); Taryn Lomas, San Diego, CA (US); James Riebel, San Diego, CA (US); Jason Kulpa, San Diego, CA (US); Michael Norman, San Diego, CA (US)

(21) Appl. No.: 14/580,081

(22) Filed: Dec. 22, 2014

Related U.S. Application Data
(60) Provisional application No. 61/919,648, filed on Dec. 20, 2013.

(51) Int. Cl. G06Q 30/02

(52) U.S. Cl. CPC G06Q 30/0261; G06Q 30/0277

(57) ABSTRACT

A webpage is opened and a set of advertisements is created based on a request transmitted to an advertisement server. A campaign database returns an optimized set of advertisements selected from the set of advertisements. A request impression is transmitted to a tracking database. A formatted advertisement set is transmitted to, and displayed on, the webpage. In response to a click event selecting an advertisement from the formatted advertisement set, the tracking server matches the consumer to the request impression. The tracking server records the matching of the click event and an advertiser bid at the time the request impression was transmitted. The advertising server sets an advertisement cookie and directs the consumer browser to an advertiser landing page. A second request is transmitted to the tracking server when the user viewing a conversion page. The tracking server matches the advertisement cookie to the request impression and records a conversion.

### TECHNICAL FIELD

The subject matter described herein relates to computer-implemented methods, software, and systems for creating, managing, and serving online enhanced click advertising campaigns.

### BACKGROUND

The value of online click advertising inventory is based on the amount of information known about the consumer that clicked on an advertisement and the location of the ad. Generally available information about consumers includes geography, device used to view adverting, time-of-day, age, and gender. Missing from this information is highly-valuable, industry-specific consumer submitted information (extended consumer data) often know by web property and network operators. Examples of extended consumer data for the automobile insurance industry include age, miles driven per year, and driving history. Advertisers often spend many times more for clicks that include extended consumer data (enhanced clicks) because of their ability to segment at a more granular level. However, capitalizing on enhanced clicks is often not worth the cost due to the amount of labor associated with managing related advertising relationships and campaigns as well as technical limitations. The result is lower revenue for web property and network operators and decreased return on investment for advertisers.

### SUMMARY

In one aspect, a computer-implemented method, system and computer program product are presented for creating, managing, and serving online enhanced click advertising campaigns. In response to user input from a user using a consumer browser, a webpage is opened by a processor. In response to the opening of the webpage, a request including transaction data is transmitted to an advertisement server. A set of advertisements is created based on the request. A campaign database returns, in response to a query from the advertising server, to the advertising server, an optimized set of advertisements, selected from the set of advertisements. Tokenized content is added to the optimized set of advertisements by the advertising server. A request impression is transmitted, by the advertising server, to a tracking database. Also, a formatted advertisement set, an advertisement query cookie, and a user ID cookie are transmitted to the webpage by the advertising server. The formatted advertising set is then displayed on the webpage. In response to a click event selecting an advertisement from the formatted advertisement set, the tracking server matches the consumer to the request impression using the advertisement query cookie and the user ID cookie. The tracking server records the matching of the click event and an advertiser bid at the time the request impression was transmitted. The advertising server sets an advertisement cookie based on the click event and directs the consumer browser to an advertiser landing page. A second request, containing advertisement cookie data, is transmitted to the tracking server based on the user viewing a conversion page containing conversion tracking code. The conversion tracking code identifies the advertisement tracking cookie. The tracking server matches the advertisement cookie to the request impression and records a conversion.

In some variations, the set of advertisements can be created based a real-time bid landscape.

In another variation, the transaction data includes publisher identification, keywords, product identifications, and all known consumer data.

In yet another variation, the request can be executed via an API call including customer location and customer demographic data.

In another variation, the matching can be based on the customer location and the customer demographic data.

In a further variation, the conversion tracking code can include a primary conversion pixel that detects the conversion.

In one variation, wherein the conversion tracking code comprises a primary conversion pixel that detects the conversion.

In an interrelated aspect, a method includes displaying a webpage including a tracking code and recording, using the tracking code, an initial click event on the webpage. Using the tracking code, the displaying of a conversion webpage is reported to an advertising system. A conversion report is generated based on the reporting of the displayed conversion webpage.

Implementations of the current subject matter can include, but are not limited to, systems and methods, as well as articles that comprise a tangibly embodied machine-readable medium operable to cause one or more machines (e.g., computers, etc.) to result in operations described herein. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an enterprise resource software system or other business software solution or architecture, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 shows an implementation of enhanced ads created, managed and served via the system as displayed through a consumer's web browser;

FIG. 2 depicts the graphical user interface used to manage Click Quality Segments;

FIG. 3 depicts the top of the graphical user interface used by an advertiser to create click advertising campaign and associated ads;

FIG. 4 depicts the bottom of the graphical user interface used by an advertiser to create click advertising campaign and associated ads;

FIG. 5 depicts the graphical user interface used to manage click advertising campaigns;

FIG. 6 depicts the graphical user interface used to manage bids for click advertising campaigns;

FIG. 7 depicts the graphical user interface used to manage product-specific filters associated with campaigns;

FIG. 8 depicts the graphical user interface used to select and upload images for use in ads;

FIG. 9 depicts the graphical user interface used to provide conversion tracking code to advertisers;

FIG. 10 depicts the graphical user interface used to fund an advertiser's account;

FIG. 11 depicts the graphical user interface used access campaign performance reports;

FIG. 12 depicts a system illustrating the flow of tracking the selection of advertisements from a webpage having advertisement display code;

FIG. 13 depicts a process flow diagram illustrating an advertisement serving flow; and

FIG. 14 depicts a process flow diagram illustrating a context for the advertisement serving flow.

When practical, similar reference numbers denote similar structures, features, or elements.

### DETAILED DESCRIPTION

To address these and potentially other issues with currently available solutions, computer-implemented methods, systems, articles of manufacture, and the like consistent with one or more implementations of the current subject matter can, among other possible advantages, provide enhanced online click advertising campaigns, as well as techniques for serving enhanced online click advertising campaigns.

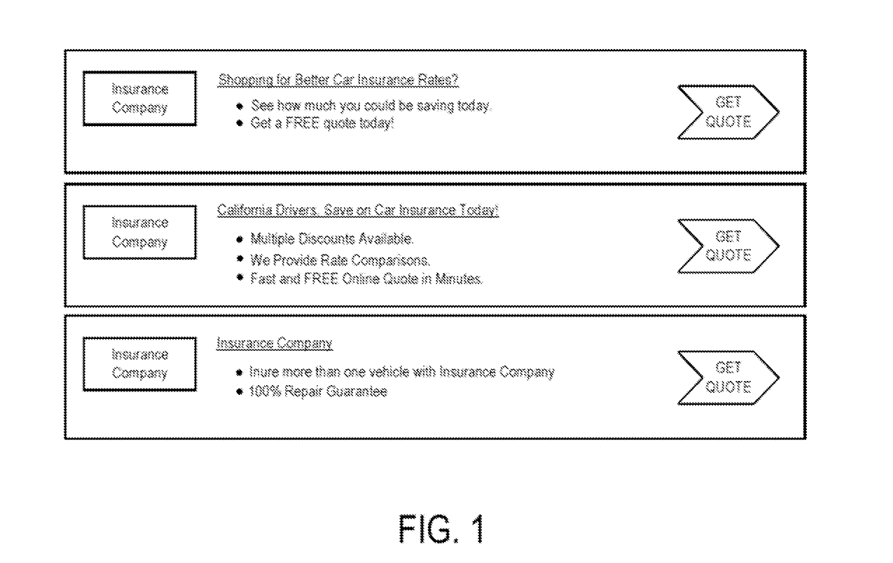

FIG. 1 shows an implementation of enhanced ads created, managed and served via the system as displayed through a consumer's web browser. Each individual ad unit was selected based on maximum revenue generation. All known consumer information (generally available and extended), the price an advertiser is willing to pay for the click, source website page, time, day of week, keywords, probability that the user will click, click quality segment, and whether or not an ad for the same advertiser appears in a higher position can be taken into consideration when selecting the ads for display and order.

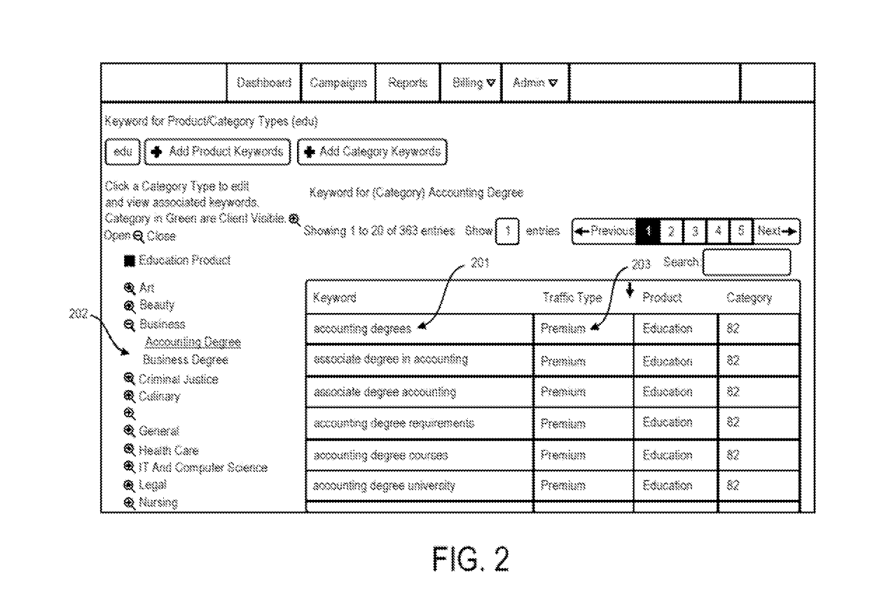

FIG. 2 depicts the graphical user interface used to manage Click Quality Segments 203. Click quality segments 203 can represent grades of clicks based on predicted and historical conversion performance. The use of segments 203 can greatly reduce campaign management burden for advertisers by limiting the number of exposed performance variables. Keywords 201 can be added to keyword categories 202 by product and placed in appropriate quality segments 203. Quality segments 203 can be adjusted by the system and/or manually over time based on conversion performance. In one implementation, the segments are Premium, General, Remnant, and Mobile. The number and labels of the segments 203 can be adjustable.

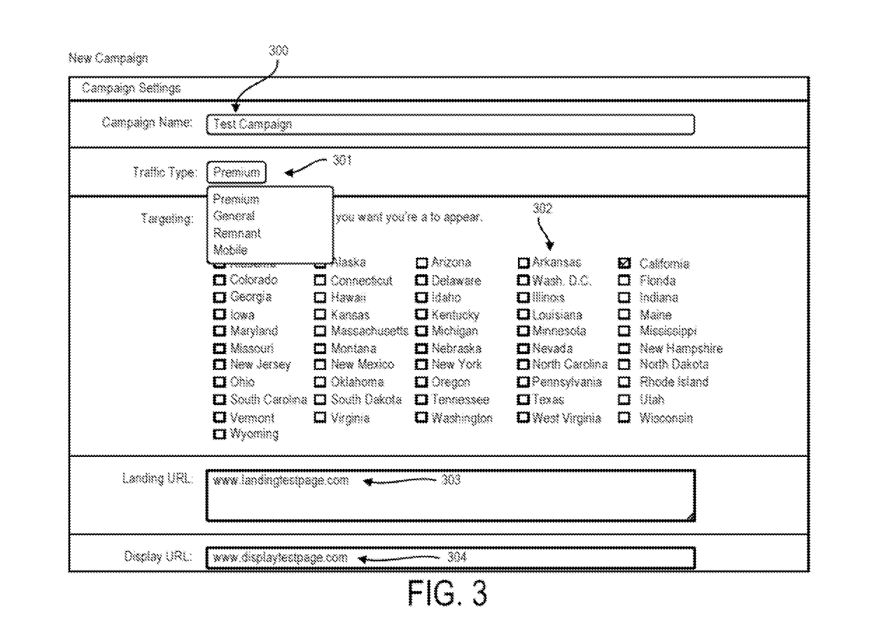

FIG. 3 depicts the top of the graphical user interface used by an advertiser to create click advertising campaign and associated ads. Campaigns can be groups of individual ads. Sections can be validated using configured business rules. For example, the system can validate that the entered URLs are properly formatted. Through this interface, advertisers can specify campaign names 300, click quality segment 301, targeting category 302, landing page URL 303, and the URL that is displayed to consumers 304.

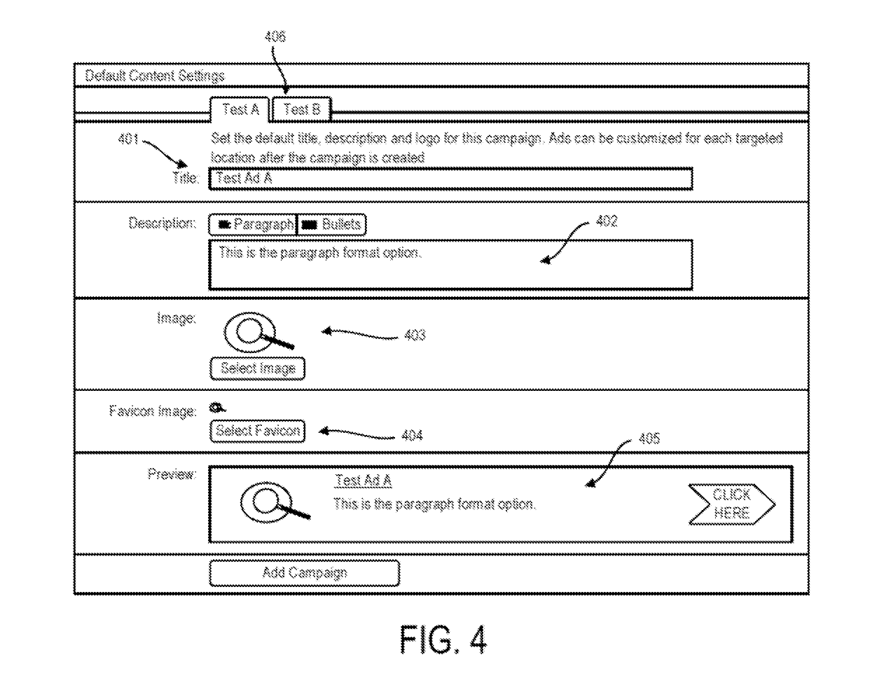

FIG. 4 depicts the bottom of the graphical user interface used by an advertiser to create click advertising campaign and associated ads. Through the interface, advertisers can specify ad title 401, ad description in paragraph or bulleted format 402, select ad image 403, select ad favicon 404 and view a live preview of ad as it would be displayed to consumers 405. In addition, a second ad can optionally be created using the Test B tab 406. If a second ad is created, the system can rotate both in the same ad space (placement) and report on relative performance.

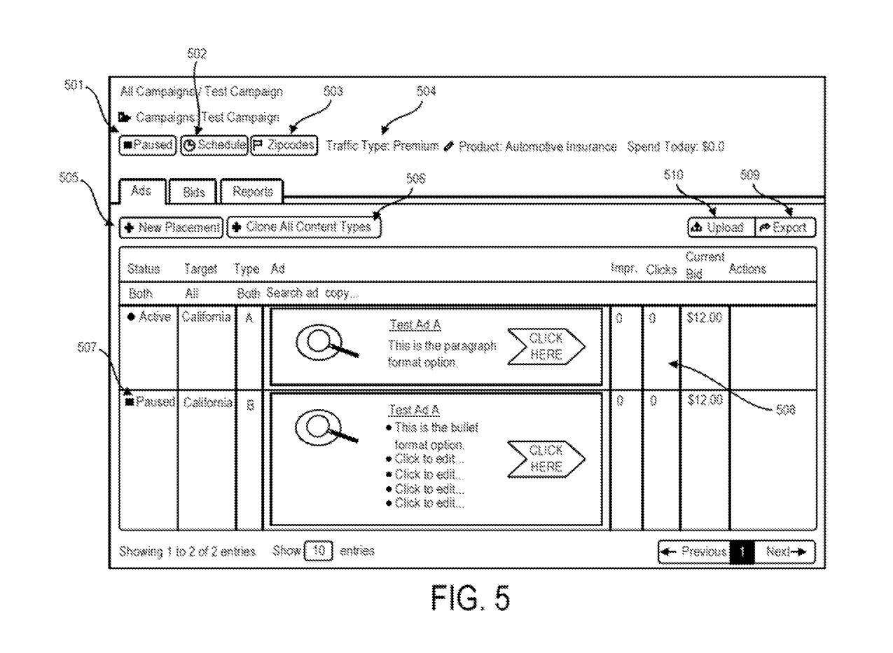

FIG. 5 depicts the graphical user interface used to manage click advertising campaigns. Through the interface, an advertiser can activate/pause the campaign 501, schedule active hours of the week 502, select additionally offered ad display filtering 503, modify click quality segment 504, create new placement 505, clone content types 506, activate/pause individual ads within placements 507, and access ad editing controls 509. The interface can also show the recorded data of customer interactions with the ads. For example, the number of clicks can be shown in a click count field 509. Advertisers that prefer to manage campaigns through offline tools may export campaign details 509 for modification and subsequently apply modification by uploading them back into the system.

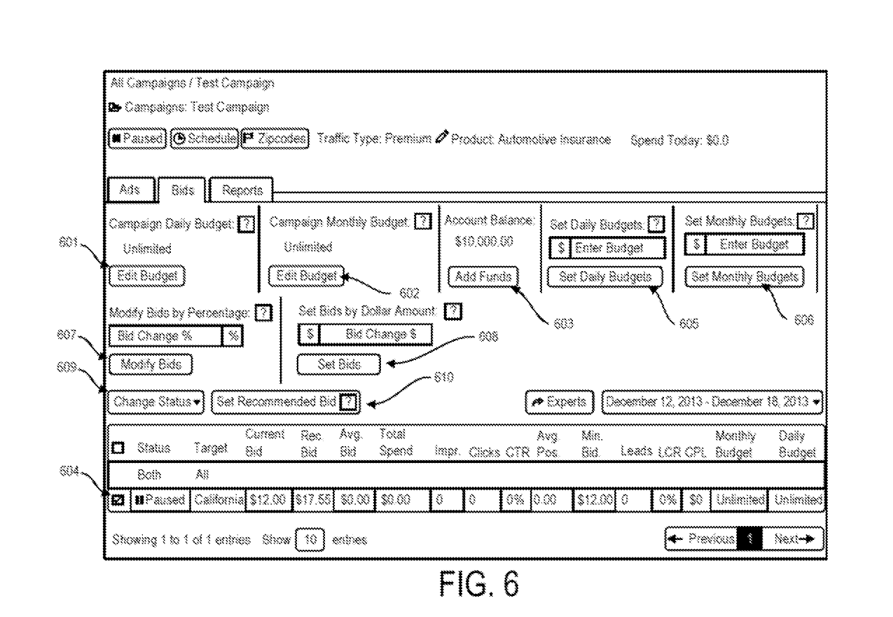

FIG. 6 depicts the graphical user interface used to manage bids for click advertising campaigns. Through the interface, advertisers can set daily 601 and monthly 602 budgets for the entire campaign and fund their account 603. By selecting one or more placements 604, an advertiser can control daily 605 and monthly 606 budgets, modify bids by percentage 607, incremental dollar amounts 608, or let the system apply the recommended bid 610 amount in order to have their ad appear in the first position in the set of ads. Advertisers can also activate/deactivate placements using the change status function 609.

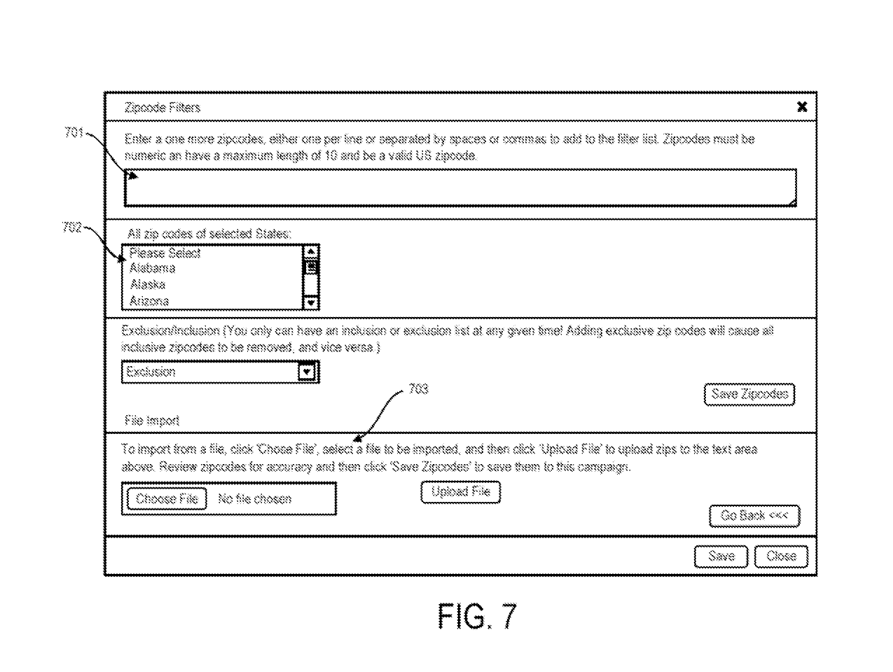

FIG. 7 depicts the graphical user interface used to manage product-specific filters associated with campaigns. In this implementation, advertisers can specify zip codes for inclusion and exclusion from their campaigns through manual entry 701, by state 702, or by uploading a file created offline 703.

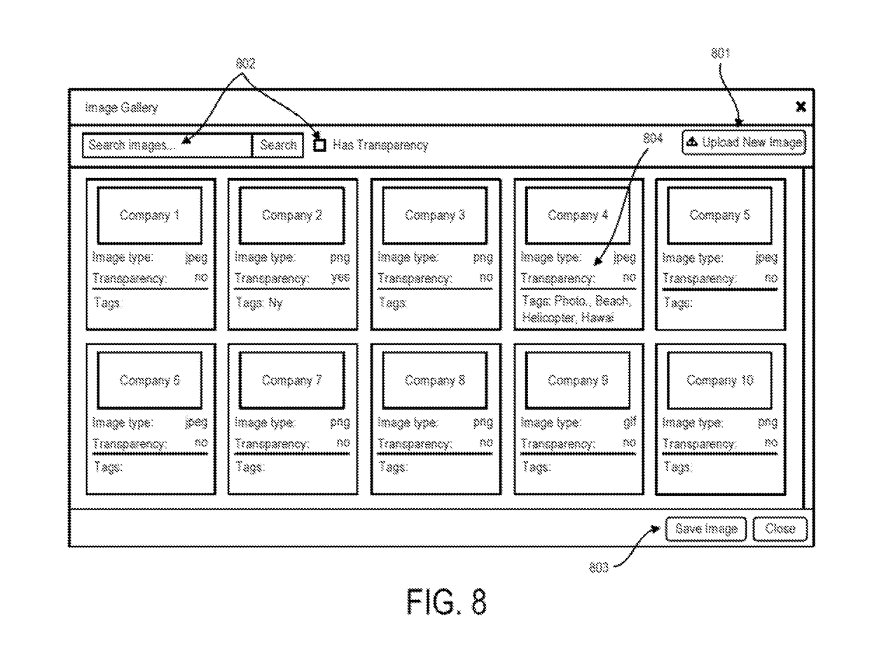

FIG. 8 depicts the graphical user interface used to select and upload images for use in ads. Through the interface, advertisers can upload new images 801, tag, and crop images that can be subsequently searched for 802, selected and saved 803 for inclusion in ads. The image type 804 can also be specified.

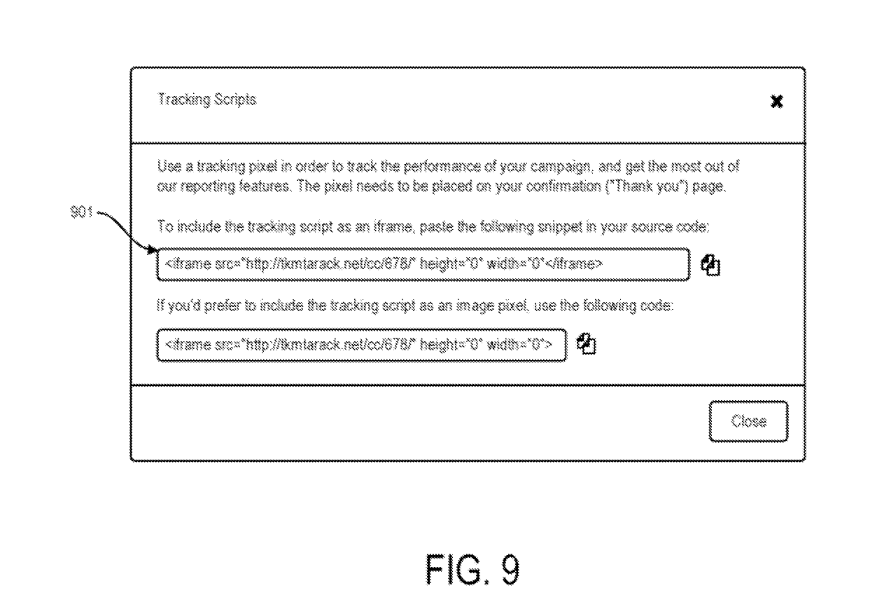

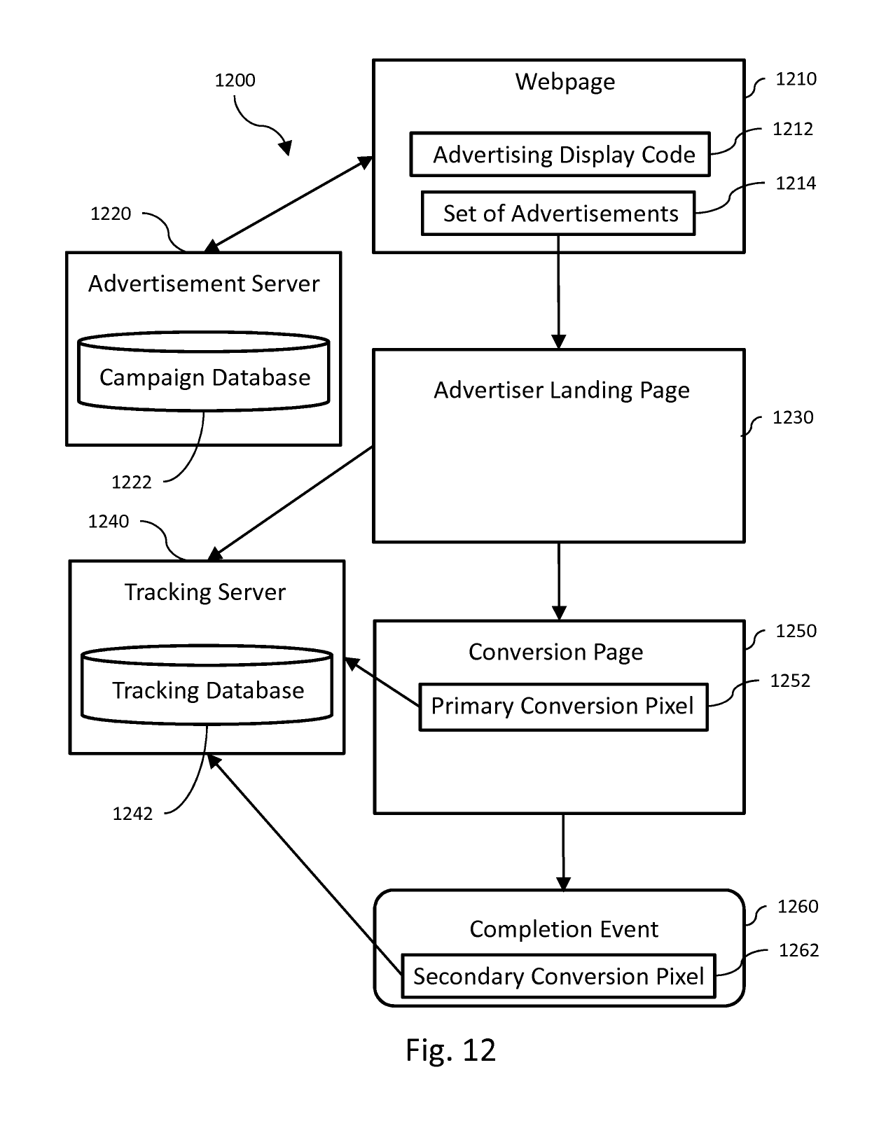

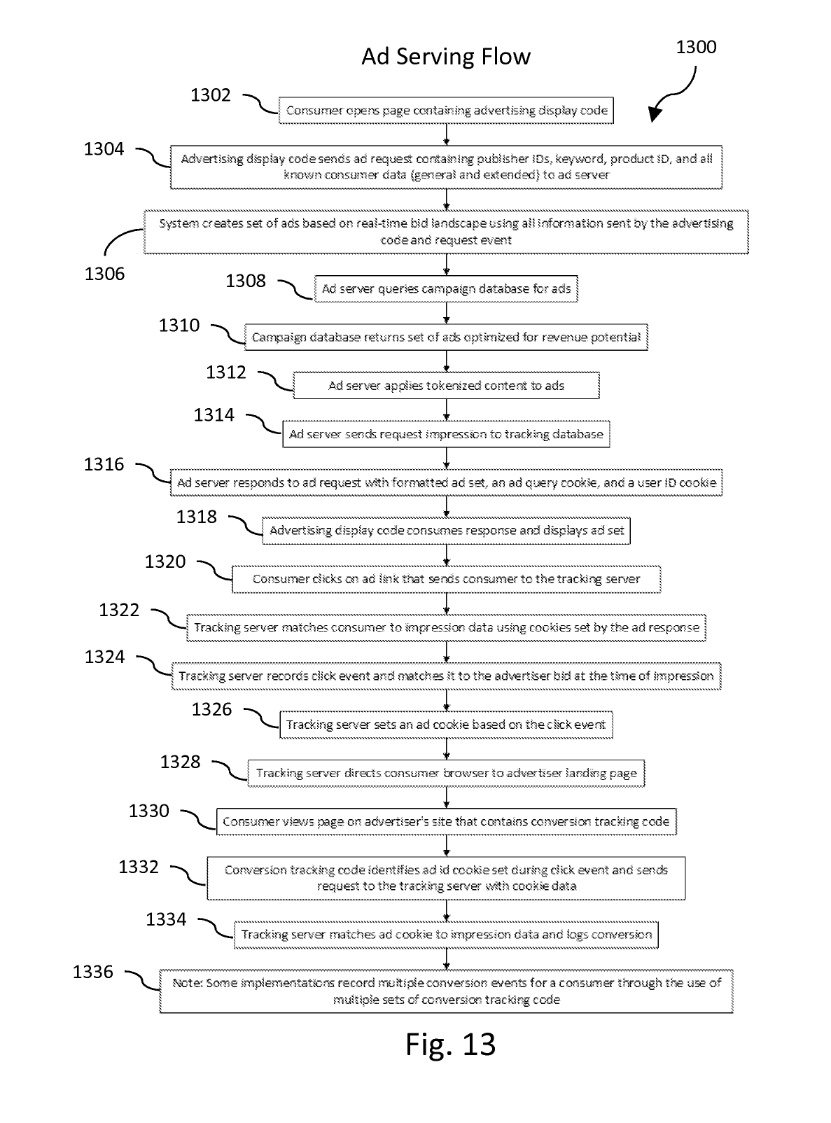

FIG. 9 depicts the graphical user interface used to provide conversion tracking code, also referred to as advertising display code, to advertisers. Through the interface, advertisers can select the type of type of advertising display code that works best for their website 901. The purpose of the advertising display code is to allow advertisers to track when consumers associated with clicks purchased through the system reach a certain page on the advertiser's website that the advertiser would consider to be a conversion. When the page with the advertising display code is rendered in a consumer's browser, it can read information from a cookie set during the initial click event and report the page view back to the advertising system. The advertising system then can present this information to advertisers in the form of conversion reporting. This process is described in greater detail in FIGS. 12 and 13.

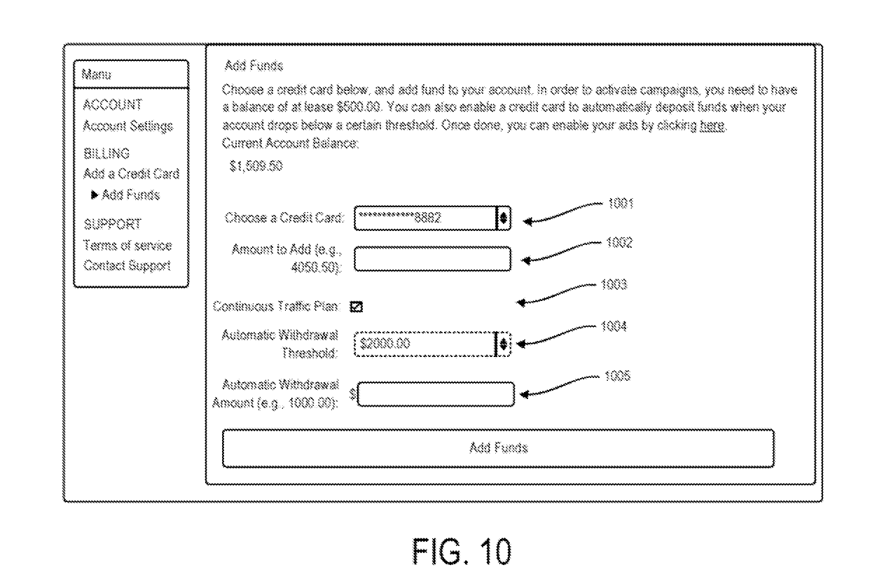

FIG. 10 depicts the graphical user interface used to fund an advertiser's account. Through the interface, advertisers can select a card for use when funding the account 1001, select a funding amount 1002, choose to have the account automatically funded so that it does not run out of funds 1003, select the threshold below which an automatic funding event will occur, and the automatic funding amount 1005.

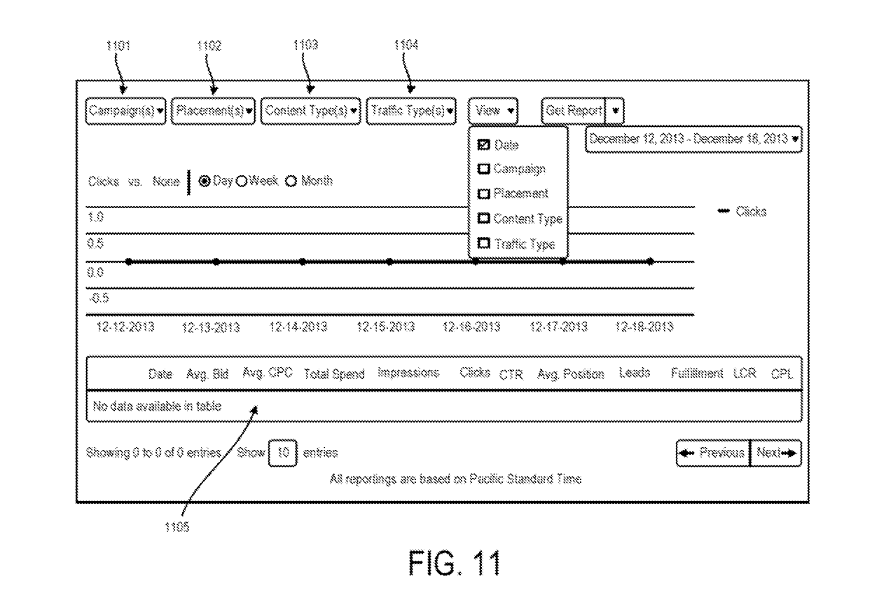

FIG. 11 depicts the graphical user interface used to access campaign performance reports. Through the interface, advertisers can view performance data based on selected campaigns 1101, placements 1102, content types 1103, and traffic types 1104. Reports are exportable and include details 1105 regarding spend, bids, resulting leads and cost.

FIG. 12 depicts a system 1200 illustrating the flow of tracking the selection from a set of advertisements 1214 from a webpage 1210 having advertising display code 1212. Users form web traffic that views webpages 1210 containing advertisements for products or services. The web traffic can be generated from publishers or other private entities.

The webpage 1210 can access an advertisement server 1220 having a campaign database 1222 to generate the set of advertisements 1214 optimized to illicit greater interest from the user based on information about the user, including the geo-location of the user and their demographics. Once an advertisement from the set of advertisements 1214 has been selected, i.e. clicked on, the user can then be taken to an advertiser landing page 1230.

The selection can be stored in a tracking server 1240 having a tracking database 1242 that records the user and the selected advertisement. The advertiser landing page 1230 can introduce the product or service to the user, whereupon the user can then participate in shopping, reviewing, etc. on the advertiser's website.

There can also be a conversion page 1250 which can be a webpage where an important intermediate step in the purchasing process is completed. In the present context, a “conversion” refers to, e.g. a quote, a lead, etc. that generally distinguishes the user's activity as being more than just incidental traffic, i.e. a good prospect for a sale exists. On the conversion page 1250, there can be a primary conversion pixel 1252, as described in FIG. 9. The primary conversion pixel 1252 detects the conversion and sends the information about the conversion, and the user, to the tracking server 1240.

If the user further converts into a completion event 1260, e.g. a sale, enrollment, policy, etc. at the point of sale on the advertiser's website there can be a secondary conversion pixel 1262, similar to the primary conversion pixel 1252, that transmits information about the completion event 1260 to the tracking server 1240. In this way, the tracking server 1240 can analyze the data about the user and the conversions that occur in order to provide feedback to the advertising campaign in order to further optimize advertisements with the system. In another implementation, there can be any number of conversion pixels throughout an advertiser's website for tracking the user's purchasing activity.

FIG. 13 depicts a process flow diagram 1300 illustrating an advertisement serving flow. The process flow diagram 1300 describes in greater detail the process outlined in FIG. 12.

At 1302, a processor, in response to input from a user using a consumer browser, opens a webpage containing the advertising display code 901. The input can be, for example, a click from a mouse, a tap on a touch screen device, a marking from a stylus, etc.

At 1304, a request, including transaction data, is transmitted to the advertisement server. The request is a request for advertisements that can be tailored to the user providing the input. The transaction data can include information about products or services the user may be interested in. For example, the transaction data can include publisher ID's, keywords, product ID's, and all known consumer data (general and extended).

At 1306, a set of advertisements is created based on the request. The creation of the set of advertisements can be based on real-time bid landscape using all information sent by the advertising code 901 and the request event. Advertisers can raise, lower, pause, and restart bids, as well as outbid other advertisers for top position. Bidding can be done based on the geo-location of the advertisements.

At 1308, the advertising server queries the campaign database for a set of advertisements designed to generate the maximum interest by the user.

At 1310, an optimized set of advertisements from the set of advertisements is returned to the advertising server by a campaign database in response to the query. The optimized set of advertisements can be optimized according to, for example, the geo-location of the user, a specified geo-location, the user's purchasing history, etc.

At 1312, tokenized content is added to the optimized set of advertisements by the advertising server. The tokens can contain search terms, dates, states, cities, zip codes, and IP addresses. The tokens can be set by the advertiser in the client portal. The tokens allow attributes such as publisher id and sub id to transfer, via click, to the advertiser's web form.

At 1314, a request impression is transmitted by the advertising server to a tracking database. The request impression is information about the request that was received by the advertising server. The information in the request impression can be used to track, for example, information about the user's purchasing habits, the response of the advertising server, etc.

At 1316, a formatted advertisement set, an advertisement query cookie, and a user ID cookie is transmitted to the webpage by the advertising server.

At 1318, the formatted advertising set is displayed on the webpage.

At 1320, a click event sends the consumer to the tracking server. At this point, the tracking server takes over the program flow and perform actions described below, in 1322 and 1324.

At 1322, in response to a click event selecting an advertisement from the formatted advertisement set, matching of the consumer to the request impression using the advertisement query cookies and the user ID cookie is done by the tracking server.

At 1324, a matching of the click event and an advertiser bid at the time the request impression was transmitted is recorded by the tracking server.

At 1326, an advertisement cookie based on the click event is set by the advertisement server.

At 1328, the consumer browser is directed to an advertiser landing page by the by the advertisement server. The advertiser landing page can be a welcome page, a catalog page, or any page desired by the advertiser to commence offering the product or service of interest to the user.

At 1330, a user views a conversion page containing conversion tracking code. The conversion page is a page that distinguishes between a casual user and a user truly interested in a product. Examples of conversion pages can be a quote page, a fillable form, a FAQ page, a lead generation page, etc.

At 1332, the conversion tracking code identifies the advertising cookie and transmits a second request to the tracking server. The second request is a request to record the detected conversion that occurred on the conversion page. To identify the user and the advertisement that the user is responding to that is resulting in the conversion, the second request can include advertising cookie data.

At 1334, the tracking server matches the advertising cookie to the request impression that was generated in 1314. This allows the tracking server 1240 to monitor conversions that occurred as a result of using webpages that contained the conversion tracking code.

At 1336, the tracking server 1240 records the conversion in the tracking database 1242.

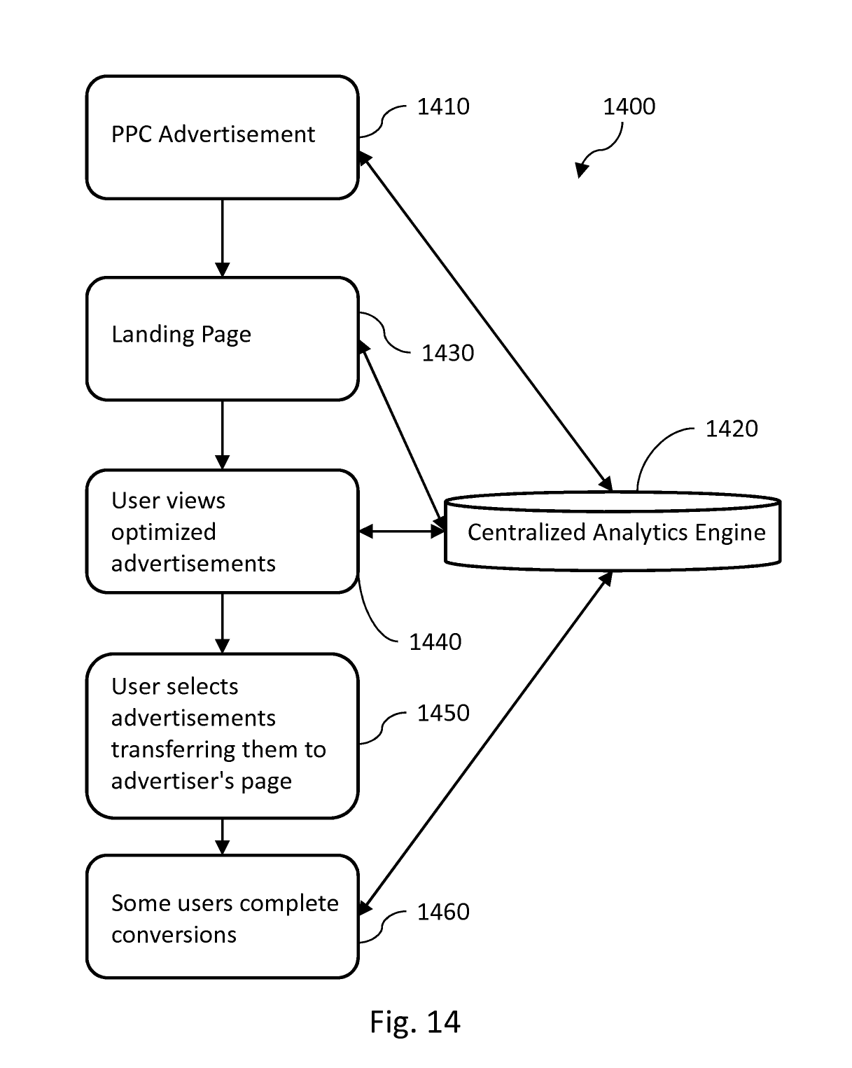

FIG. 14 depicts a process flow diagram 1400 illustrating a context for the advertisement serving flow. The processes described above can be placed into context by examining an exemplary workflow.

At 1410, a pay-per-click (PPC) advertisement is provided by an advertisement server to a webpage, for example, an advertisement originating from FACEBOOK, GOOGLE, etc. that a user can click on when viewing the webpage containing the advertisement. When a user clicks the PPC advertisement, information about that advertisement is stored on a centralized analytics engine 1420, as in 1210, 1302, and 1304. The information can include, for example, traffic source, platform (e.g., browser type, computer operating system, etc.), advertisement identification, and target demographic, etc. The centralized analytics engine 1420 can be stored and executed on the advertisement server 1220.

At 1430, a landing page is generated and displayed that allows a user to select which advertisement pages they wish to view. Data points can be stored by the centralized analytics engine 1420. The data points can include information about the advertisement pages, for example, domain name, images, and text, etc.

At 1440, a user views an optimized set of advertisements provided by the centralized analytics engine 1420, similar to 1214, 1306, and 1310. The system uses data collected by the centralized analytics engine 1420 to determine whether to show premium, standard, remnant, or mobile advertisements. This determination can be based upon, for example, examining the domain, webpage, advertisement data, traffic source data, and consumer data, etc.

At 1450, the consumer selects advertisements transferring them to an advertiser's page, as described in 1328. The user then views the selected product or service offered by the advertiser.

At 1460, a percentage of users convert, i.e. receive a quote or make a purchase, as described in 1330-1336. The advertiser's webpage can use an API to record the conversion event. The tracking database 1442 can then store the conversion along with information about, for example, the advertiser, tracking source, webpage, and consumer data points, etc.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT), a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method comprising:
opening, by a processor in response to user input from a user using a consumer browser, a webpage containing advertising display code;
transmitting, to an advertisement server and in response to the opening, a request including transaction data;
creating a set of advertisements based on the request;
returning, to the advertising server by a campaign database and in response to a query from the advertising server, an optimized set of advertisements from the set of advertisements;
adding, by the advertising server, tokenized content to the optimized set of advertisements;
transmitting, by the advertising server, a request impression to a tracking database;
transmitting, to the webpage by the advertising server, a formatted advertisement set, an advertisement query cookie, and a user ID cookie;
displaying, on the webpage, the formatted advertising set;
matching, by the tracking server and in response to a click event selecting an advertisement from the formatted advertisement set, the consumer to the request impression using the advertisement query cookies and the user ID cookie;
recording, by the tracking server, a matching of the click event and an advertiser bid at the time the request impression was transmitted;
setting, by the advertisement server, an advertisement cookie based on the click event;
directing, by the advertisement server, the consumer browser to an advertiser landing page;
transmitting, based on the user viewing a conversion page containing conversion tracking code, a second request to the tracking server,
wherein the conversion tracking code identifies the advertisement cookie, and
wherein the second request includes advertisement cookie data;
matching, by the tracking server, the advertisement cookie to the request impression; and
recording, by the tracking server, of a conversion.

2. The method of claim 1, wherein the creating is further based on a real-time bid landscape.

3. The method of claim 1, wherein the transaction data comprises publisher identification, keywords, product identifications, and all known consumer data.

4. The method of claim 1, wherein the request is executed via an API call including customer location and customer demographic data.

5. The method of claim 4, wherein the matching is based on the customer location and the customer demographic data.

6. The method of claim 1, wherein the conversion tracking code comprises a primary conversion pixel that detects the conversion.

7. The method of claim 1, wherein the conversion tracking code comprises a secondary conversion pixel that detects a completion event.

8. A method comprising:
displaying a webpage including a tracking code;
recording, using the tracking code, an initial click event on the webpage;
reporting, to an advertising system using the tracking code, the displaying of a conversion webpage; and
generating a conversion report based on the reporting of the displayed conversion webpage.

9. A computer program product comprising a non-transitory machine-readable medium storing instructions that, when executed by at least one programmable processor, cause the at least one programmable processor to perform operations comprising:
opening, by a processor in response to user input from a user using a consumer browser, a webpage containing advertising display code;
transmitting, to an advertisement server and in response to the opening, a request including transaction data;
creating a set of advertisements based on the request;
returning, to the advertising server by a campaign database and in response to a query from the advertising server, an optimized set of advertisements from the set of advertisements;
adding, by the advertising server, tokenized content to the optimized set of advertisements;
transmitting, by the advertising server, a request impression to a tracking database;
transmitting, to the webpage by the advertising server, a formatted advertisement set, an advertisement query cookie, and a user ID cookie;
displaying, on the webpage, the formatted advertising set;
matching, by the tracking server and in response to a click event selecting an advertisement from the formatted advertisement set, the consumer to the request impression using the advertisement query cookies and the user ID cookie;
recording, by the tracking server, a matching of the click event and an advertiser bid at the time the request impression was transmitted;
setting, by the advertisement server, an advertisement cookie based on the click event;
directing, by the advertisement server, the consumer browser to an advertiser landing page;
transmitting, based on the user viewing a conversion page containing conversion tracking code, a second request to the tracking server,
wherein the conversion tracking code identifies the advertisement cookie, and
wherein the second request includes advertisement cookie data;
matching, by the tracking server, the advertisement cookie to the request impression; and
recording, by the tracking server, of a conversion.

10. The method of claim 9, wherein the creating is further based on a real-time bid landscape.

11. The method of claim 9, wherein the transaction data comprises publisher identification, keywords, product identifications, and all known consumer data.

12. The method of claim 9, wherein the request is executed via an API call including customer location and customer demographic data.

13. The method of claim 12, wherein the matching is based on the customer location and the customer demographic data.

14. The method of claim 9, wherein the conversion tracking code comprises a primary conversion pixel that detects the conversion.

15. The method of claim 9, wherein the conversion tracking code comprises a secondary conversion pixel that detects a completion event.

16. A system comprising:
at least one programmable processor; and
a non-transitory machine-readable medium storing instructions that, when executed by the at least one processor, cause the at least one programmable processor to perform operations comprising:
opening, by a processor in response to user input from a user using a consumer browser, a webpage containing advertising display code;
transmitting, to an advertisement server and in response to the opening, a request including transaction data;
creating a set of advertisements based on the request;
returning, to the advertising server by a campaign database and in response to a query from the advertising server, an optimized set of advertisements from the set of advertisements;
adding, by the advertising server, tokenized content to the optimized set of advertisements;
transmitting, by the advertising server, a request impression to a tracking database;
transmitting, to the webpage by the advertising server, a formatted advertisement set, an advertisement query cookie, and a user ID cookie;
displaying, on the webpage, the formatted advertising set;
matching, by the tracking server and in response to a click event selecting an advertisement from the formatted advertisement set, the consumer to the request impression using the advertisement query cookies and the user ID cookie;
recording, by the tracking server, a matching of the click event and an advertiser bid at the time the request impression was transmitted;
setting, by the advertisement server, an advertisement cookie based on the click event;
directing, by the advertisement server, the consumer browser to an advertiser landing page;
transmitting, based on the user viewing a conversion page containing conversion tracking code, a second request to the tracking server,
wherein the conversion tracking code identifies the advertisement cookie, and
wherein the second request includes advertisement cookie data;
matching, by the tracking server, the advertisement cookie to the request impression; and
recording, by the tracking server, of a conversion.

17. The method of claim 16, wherein the creating is further based on a real-time bid landscape.

18. The method of claim 16, wherein the transaction data comprises publisher identification, keywords, product identifications, and all known consumer data.

19. The method of claim 16, wherein the conversion tracking code comprises a primary conversion pixel that detects the conversion.

20. The method of claim 16, wherein the conversion tracking code comprises a secondary conversion pixel that detects a completion event.
